(19) United States
(12) Patent Application Publication
(10) Pub. No.: US 2026/0105020 A1
(43) Pub. Date: Apr. 16, 2026

(54) pDBI Logic Circuit, Semiconductor Device Including the Same, and pDBI Encoding Method using the Same

(71) Applicant: Kwangwoon University Industry-Academic Collaboration Foundation, Seoul (KR)

(72) Inventors: Ki Soo LEE, Seoul (KR); Chan Heum HAN, Seoul (KR); Joo Hyung CHAE, Seoul (KR)

(21) Appl. No.: 18/913,317

(22) Filed: Oct. 11, 2024

(30) Foreign Application Priority Data
Apr. 11, 2024 (KR) 10-2024-0048764

(51) Int. Cl. G06F 13/42

(52) U.S. Cl. CPC G06F 13/4282

(57) ABSTRACT

A pDBI encoding method comprising: generating sequence data; grouping the sequence data according to a predetermined burst length; generating process sequence data and pDBI (partial-Data Bus Inversion) based on the grouped sequence data; and generating PAM3 (3-level pulse amplitude modulation) output data based on the process sequence data and the pDBI.

### CROSS-REFERENCE TO RELATED APPLICATION

This application claims priority under 35 U.S.C § 119 to Korean Patent Application No. 10-2024-0048764 filed on Apr. 11, 2024, in the Korean Intellectual Property Office, the entire contents of which are hereby incorporated by reference.

### TECHNICAL FIELD

The present invention relates to a partial-Data Bus Inversion (pDBI) logic circuit, a semiconductor device including the same, and a pDBI encoding method using the same.

### BACKGROUND

The statements in this section merely provide background information related to the present embodiment and do not necessarily constitute the prior art.

Data bus inversion encoding (DBI encoding) is widely used to reduce power consumption in data transmission. When DBI encoding is performed, a separate DBI input/output lane is provided to determine whether data bus inversion occurs.

Meanwhile, since the burst length that a memory device can input or output at one time is a power of 2, in the case of the 3-level Pulse Amplitude Modulation (PAM3) signaling method, dummy data is always transmitted together when transmitting data. Accordingly, there is a limit to the reduction in the actual data transmission rate per pin due to the dummy data.

Furthermore, when DBI encoding is performed using the PAM3 signaling method, there is a problem that additional power and area are consumed due to the dummy data and DBI input/output lanes. Therefore, if a circuit that transmits data for DBI encoding instead of dummy data is provided, it is expected that the power consumed for data transmission can be reduced and efficiency can be maximized.

### CITATION LIST

### Patent Literature

Korean Patent Application Publication No. 10-2022-0050663

### SUMMARY

An object of the present invention is to provide a pDBI logic circuit that transmits DBI encoding data instead of dummy data using the PAM3 signaling method.

Another object of the present invention is to provide a semiconductor device including the pDBI logic circuit that transmits DBI encoding data instead of dummy data using the PAM3 signaling method.

Another object of the present invention is to provide a pDBI encoding method using the pDBI logic circuit that transmits DBI encoding data instead of dummy data using the PAM3 signaling method.

The objects of the present invention are not limited to the objects mentioned above, and other objects and advantages of the present invention that are not mentioned can be understood by the following description and will be more clearly understood from the embodiments of the present invention. Additionally, it will be readily apparent that the objects and advantages of the present invention can be realized by the means and combinations thereof indicated in the patent claims.

According to some aspects of the disclosure, a pDBI encoding method comprises: generating sequence data; grouping the sequence data according to a predetermined burst length, generating process sequence data and pDBI (partial-Data Bus Inversion) based on the grouped sequence data, and generating PAM3 (3-level pulse amplitude modulation) output data based on the process sequence data and the pDBI.

According to some aspects, the generating of the process sequence data and the pDBI comprises: generating the pDBI based on a first part of the grouped sequence data; and generating the process sequence data based on the grouped sequence data and the pDBI

According to some aspects, the generating of the pDBI comprises: performing an addition of the first part; generating a first pDBI if a result value of the addition exceeds a predetermined criterion; and generating a second pDBI different from the first pDBI if the result value of the addition is equal to or less than the predetermined criterion.

According to some aspects, the generating of the process sequence data comprises: generating first data based on the first part of the grouped sequence data and the pDBI; generating second data based on a second part different from the first part of the grouped sequence data; and generating the process sequence data by combining the first data and the second data.

According to some aspects, the generating of the first data comprises: generating the first data by performing data bus inversion on the first part if the pDBI is the first pDBI; and generating the first data without performing data bus inversion on the first part if the pDBI is not the first pDBI.

According to some aspects, the generating of the PAM3 output data further comprises: serializing the process sequence data and the pDBI to generate embedded sequence data; and PAM3—encoding the embedded sequence data to generate the PAM3 output data.

According to some aspects, the generating of the embedded sequence data further comprises: serializing the process sequence data based on the burst length; serializing the pDBI; and serializing the serialized process sequence data and the serialized pDBI based on a predetermined mode to generate the embedded sequence data.

According to some aspects, the predetermined mode is a mode for pulse amplitude modulation.

According to some aspects of the disclosure, a pDBI logic circuit comprises: a pDBI encoder that generates a pDBI based on a first part of sequence data, a data inversion unit that generates first data based on the first part of the sequence data and the pDBI, and an amplifier that amplifies a second part different from the first part of the sequence data to generate second data.

According to some aspects, the second part is a remaining part of the sequence data excluding the first part.

According to some aspects, the pDBI encoder comprises: an adder that receives the first part of the sequence data and performs an addition; and a Most Significant Bit (MSB) selector that receives a result value of the adder and outputs the pDBI.

According to some aspects, the MSB selector is configured to: generate a first pDBI if the result value of the adder exceeds a predetermined criterion, and generate a second pDBI different from the first pDBI if the result value of the adder is equal to or less than the predetermined criterion.

According to some aspects, the data inversion unit generates the first data by inverting the first part of the sequence data based on the pDBI.

According to some aspects, the data inversion unit comprises: a first part that amplifies the first part; a second part that inverts the first part; and a multiplexer which receives the first part and the inverted first part and performs inversion of the first part.

According to some aspects of the disclosure, a semiconductor device comprises: a sequence generator that generates sequence data, a pDBI logic circuit that receives the sequence data according to a predetermined burst length and outputs process sequence data and pDBI for the sequence data; and a driver that generates PAM3 output data based on the process sequence data and the pDBI, wherein the pDBI is data regarding whether a data bus inversion occurs between the sequence data and the process sequence data.

According to some aspects, a serializer that serializes the process sequence data and the pDBI to output embedded sequence data; and a PAM3 encoder that PAM3—encodes the embedded sequence data and transmits it to the driver.

According to some aspects, the serializer comprises: a first serializer that serializes the process sequence data based on the burst length; a second serializer that serializes the pDBI; and a third serializer that serializes the serialized process sequence data and the serialized pDBI based on a predetermined mode.

According to some aspects, the predetermined mode is a mode for pulse amplitude modulation.

Aspects of the disclosure are not limited to those mentioned above and other objects and advantages of the disclosure that have not been mentioned can be understood by the following description and will be more clearly understood according to embodiments of the disclosure. In addition, it will be readily understood that the objects and advantages of the disclosure can be realized by the means and combinations thereof set forth in the claims.

The pDBI logic circuit of the present invention, the semiconductor device including the same, and the pDBI encoding method using the same can transmit DBI encoding data by embedding it in sequence data using the PAM3 signaling method. By doing so, the device can be miniaturized by eliminating the DBI input/output lane, and the pin efficiency can be maximized to minimize power consumption.

In addition to the above-described content, specific advantages of the present invention are described below while describing specific details for carrying out the invention.

### BRIEF DESCRIPTION OF THE DRAWINGS

FIG. 1 is a block diagram for describing a semiconductor device including a pDBI logic circuit according to some embodiments of the present invention.

FIG. 2 is a block diagram for describing the pDBI logic circuit and sequence generator of FIG. 1 in detail.

FIG. 3 is a block diagram for describing the serializer of FIG. 1 in detail.

FIG. 4 is a drawing for describing the pDBI logic circuit of FIG. 2 and the embedded sequence data of FIG. 3 in detail.

FIG. 5 is a drawing for describing the embedded sequence data of FIG. 1 in detail.

FIG. 6 is a block diagram for describing the modulation encoder of FIG. 1 in detail.

FIG. 7 is a drawing for describing embedded sequence data of FIG. 1.

FIG. 8 is a drawing for describing a semiconductor device according to some embodiments of the present invention.

FIG. 9 is a drawing for describing a semiconductor device according to some embodiments of the present invention.

FIG. 10 is a diagram for describing the operation of the modulation encoder and the PAM3 driver of FIG. 8 and the NRZ driver of FIG. 9.

FIG. 11 is a drawing for describing the interface of the semiconductor device of FIG. 8.

FIG. 12 is a flowchart for describing a pDBI encoding method using a pDBI logic circuit according to some embodiments of the present invention.

FIG. 13 is a flowchart for describing the process sequence data and pDBI generation steps of FIG. 12 in detail.

FIG. 14 is a flowchart for describing the first data generation step of FIG. 13 in detail.

FIG. 15 is a flowchart for describing the PAM3 output data generation step of FIG. 12 in detail.

FIG. 16 is a diagram for describing a hardware configuration of a pDBI logic circuit or a semiconductor device that performs a pDBI encoding method according to some embodiments of the present invention.

### DETAILED DESCRIPTION OF THE PREFERRED EMBODIMENTS

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc. should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

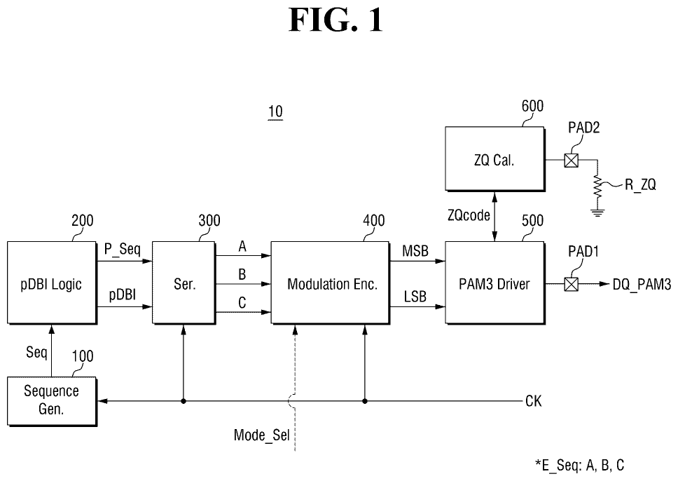

Hereinafter, with reference to FIGS. 1 to 8, a pDBI logic circuit according to some embodiments of the present invention and a semiconductor device including the same will be described.

FIG. 1 is a block diagram for describing a semiconductor device including a pDBI logic circuit according to some embodiments of the present invention.

Referring to FIG. 1, a semiconductor device 1 (hereinafter, referred to as a semiconductor device) including a pDBI logic circuit according to some embodiments of the present invention includes a sequence generator 100, a pDBI logic circuit 200, a serializer 300, a modulation encoder 400, a driver 500, and a ZQ calibration circuit 600.

The sequence generator 100 may receive a clock signal CK and generate sequence data Seq that matches a frequency included in the clock signal CK. In this case, the sequence generator 100 may generate the sequence data Seq using a random number. For example, the sequence generator 100 may be a pseudorandom number generator. The sequence generator 100 may transmit the generated sequence data Seq to the pDBI logic circuit 200. In this case, the sequence generator 100 may divide the sequence data Seq according to the burst length of the memory device and transmit it to the pDBI logic circuit 200.

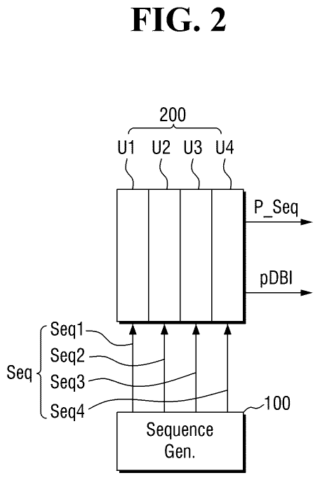

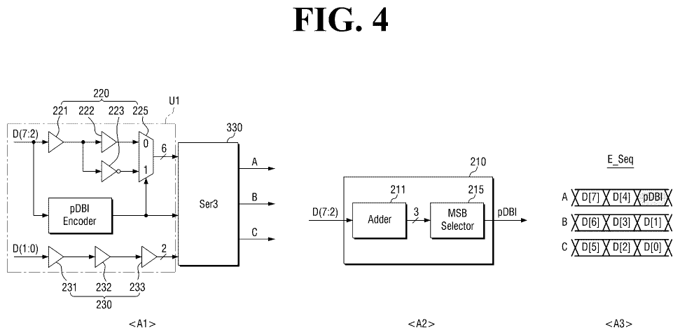

The pDBI logic circuit 200 may receive the sequence data Seq from the sequence generator 100 and generate process sequence data P_Seq and pDBI based on the sequence data. A specific description of the pDBI logic circuit 200 will be described later with reference to FIGS. 2 and 4.

The serializer 300 may receive the process sequence data P_Seq and pDBI from the pDBI logic circuit 200 and generate embedded sequence data E_Seq using the same. In this case, the serializer 300 may receive a clock signal CK and generate embedded sequence data E_Seq using the same. The embedded sequence data E_Seq may be a combination of process sequence data P_Seq and pDBI. For example, using the PAM3 signaling method, the embedded sequence data E_Seq may be output through a first lane A, a second lane B, and a third lane C.

The modulation encoder 400 may receive 3-bit embedded sequence data E_Seq from the serializer 300 through the first to third lanes A, B, and C. In addition, the modulation encoder 400 may receive a mode selection signal Mode_Sel and a clock signal CK. Here, the mode selection signal Mode_Sel may be for at least one of the amplitude level and polarity of pulse amplitude modulation (PAM). In the case of the PAM3 signaling method, the amplitude level may be 3, and the polarity may be single where all pulses are positive, or double where the pulses include positive and negative. The modulation encoder 400 may output the most significant bit (MSB) and least significant bit (LSB) based on the embedded sequence data E_Seq.

The PAM3 driver 500 may receive the most significant bit (MSB) and least significant bit (LSB) from the modulation encoder 400 and generate PAM3 output data DQ_PAM3 using the same. The generated PAM3 output data DQ_PAM3 may be output to an external device (for example, a channel or receiver) through a first pad PAD1 connected to the PAM3 driver 500.

The ZQ calibration circuit 600 may perform ZQ calibration like the PAM3 driver 500. In this case, the ZQ calibration circuit 600 may be connected to an external resistor R_ZQ through a second pad PAD2 and may perform ZQ calibration by exchanging a ZQ code ZQcode with the PAM3 driver 500. By doing so, the ZQ calibration circuit 600 may reduce the reflection of a signal transmitted from a semiconductor device and improve signal integrity.

Here, the first pad PAD1 and the second pad PAD2 may connect the semiconductor device of the present invention and an external device to perform input or output of a signal.

FIG. 2 is a block diagram for describing the pDBI logic circuit and sequence generator of FIG. 1 in detail.

Hereinafter, a case in which the sequence generator 100 generates a 32-bit sequence will be described as an example. However, the present embodiment is not limited thereto, and the number of bits of the sequence data Seq generated by the sequence generator 100 and the number of logic units included in the pDBI logic circuit 200 may be modified and implemented as needed.

Referring to FIG. 2, the sequence generator 100 may generate a 32-bit sequence, divide it, and transmit it to the pDBI logic circuit 200. In this case, the sequence generator 100 may divide the sequence based on the burst length of the memory device. Hereinafter, a case in which the burst length of the memory device is 8 will be described as an example. Accordingly, the sequence generator 100 may divide the 32-bit sequence data Seq into 8-bit units to generate first to fourth sequences Seq1 to Seq4.

The pDBI logic circuit 200 may include first to fourth logic units U1 to U4. In this case, since the burst lengths are 8, the 32-bit sequence generated by the sequence generator 100 may be divided into first to fourth sequences Seq1 to Seq4 and input to the first to fourth logic units U1 to U4, respectively. In this case, the first to fourth sequences Seq1 to Seq4 may each include an 8-bit sequence.

The first to fourth logic units U1 to U4 may perform operations on the first to fourth sequences Seq1 to Seq4, respectively, to generate the first to fourth process sequence data and the first to fourth pDBIs. Here, each logic unit may perform operations on one sequence to generate one process sequence data and one pDBI. In this case, the detailed structures of the first to fourth logic units U1 to U4 may be configured identically. Specific details of the first to fourth logic units U1 to U4 will be described later with reference to FIG. 4.

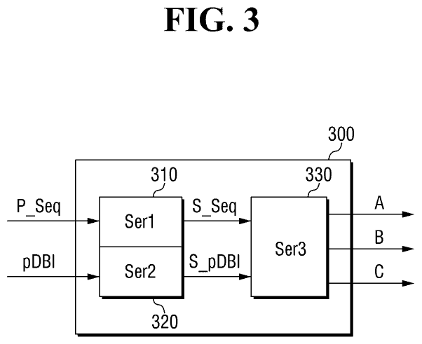

FIG. 3 is a block diagram for describing the serializer of FIG. 1 in detail.

Referring to FIG. 3, the serializer 300 may include the first to third serializers 310 to 330.

The first serializer 310 may receive process sequence data P_Seq from the pDBI logic circuit 200 and perform serialization. Serialization may be an operation of synthesizing signals input in parallel according to a clock.

In this case, the first serializer 310 may receive the first to fourth process sequence data of the first to fourth logic units U1 to U4 and perform serialization thereon. For example, the first serializer 310 may perform serialization for 8 bits each for 32 bits included in the first to fourth process sequence data. By doing so, the first serializer 310 may generate serial sequence data S_Seq that serializes the process sequence data P_Seq. In this case, if the process sequence data P_Seq is 32 bits, four 8-bit serial sequence data S_Seq may be generated. Here, the 8 bits may be a value set to be the same as the burst length.

The second serializer 320 may receive pDBI from the pDBI logic circuit 200 and perform serialization. In this case, the second serializer 320 may receive the first to fourth pDBIs of the first to fourth logic units U1 to U4 and perform serialization thereon. For example, the second serializer 320 may perform serialization for each of the four bits included in the first to fourth pDBIs. By doing so, the second serializer 320 may generate serial pDBI S_pDBI that serializes pDBI. In this case, four 1-bit serial pDBIs S_pDBI may be generated.

The third serializer 330 may receive the serial sequence data S_Seq and the serial pDBI S_pDBI and serialize it to generate embedded sequence data E_Seq. For example, the third serializer 330 may perform serialization for three bits each for 8-bit serial sequence data S_Seq and 1-bit serial pDBI S_pDBI. By doing so, the third serializer 330 may generate embedded sequence data E_Seq that combines the serial sequence data S_Seq and the serial pDBI S_pDBI. In this case, since it is a PAM3 signaling method, the embedded sequence data E_Seq may be transmitted to the modulation encoder 400 through three lanes of A, B, and C.

FIG. 4 is a drawing for describing the pDBI logic circuit of FIG. 2 and the embedded sequence data of FIG. 3 in detail.

<A1> of FIG. 4 is a drawing for describing the generation of embedded sequence data E_Seq using the first logic unit U1 and the third serializer 330 by taking the case in which the sequence data Seq is 8 bits as an example.

<A2> of FIG. 4 is a drawing for describing the pDBI encoder of <A1> in detail.

<A3> of FIG. 4 is a drawing for describing the embedded sequence data output from the third serializer of <A1> in detail.

Referring to <A1> of FIG. 4, the first logic unit U1 may include a pDBI encoder 210, a data inversion unit 220, and an amplifier 230.

The first logic unit U1 may divide the 8-bit sequence data Seq into a first part D[7:2] and a second part D[1:0]. Here, the second part D[1:0] may include 2 bits out of the 8 bits of the sequence data Seq. In addition, the first part D[7:2] may include the remaining 6 bits out of the 8 bits of the sequence data Seq.

Here, the first to eighth data D[0] to D[7] each may be 1-bit binary data.

The first part D[7:2] may be input to the pDBI encoder 210 and the data inversion unit 220. Referring to <A2>, the pDBI encoder 210 may include an adder 211 and an MSB (Most Significant Bit) selector 215.

The adder 211 may receive a first part D[7:2] as input, perform an addition, and generate a result value for the addition. The number of bits of the result value generated from the adder 211 may be smaller than that of the first part D[7:2]. For example, the number of bits of the result value generated from the adder 211 may be 3, which is half of the number of bits of the first part D[7:2].

The MSB selector 215 may receive a result value of the adder and generate a pDBI based on the result value. The MSB selector 215 may compare the result value of the adder 211 with a predetermined criterion, and determine the pDBI as a first pDBI or a second pDBI accordingly.

For example, the adder 211 may generate an addition value obtained by adding the third to eighth data D[2] to D[7] as a result value. Then, if the addition value exceeds a predetermined criterion, the MSB selector 215 may determine the pDBI as the first pDBI. On the other hand, if the addition value is equal to or lower than the predetermined criterion, the MSB selector 215 may determine the pDBI as the second pDBI that is different from the first pDBI.

The data inversion unit 220 may include a first part 222, a second part 223, and a multiplexer 225. The first part 222 may amplify the first part D[7:2]. The second part 223 may invert the first part D[7:2]. The multiplexer 225 may receive the amplified first part D[7:2] from the first part 222 and the inverted first part D[7:2] from the second part 223. In addition, the multiplexer 225 may receive the pDBI from the pDBI encoder 210 and perform inversion on the first part D[7:2] using the pDBI to generate first data. The number of bits of the first data may be 6 bits, which is the same as the number of bits of the first part D[7:2]. Additionally, the data inversion unit 220 may further include a third part 221 that amplifies the first part D[7:2] and transmits it to the first part 222.

The amplifier 230 may amplify the second part D[1:0] to generate second data. The amplifier 230 may amplify the second part D[1:0] using first to third amplifiers 231 to 233 to generate second data. The number of bits of the second data may be 2 bits, which is the same as the number of bits of the second part D[1:0].

Referring to <A3>, the pDBI generated by the MSB selector 215 may be embedded on the first lane A. In this case, the pDBI may be output from the third serializer 330 at the same time as the first data D[0] and the second data D[1].

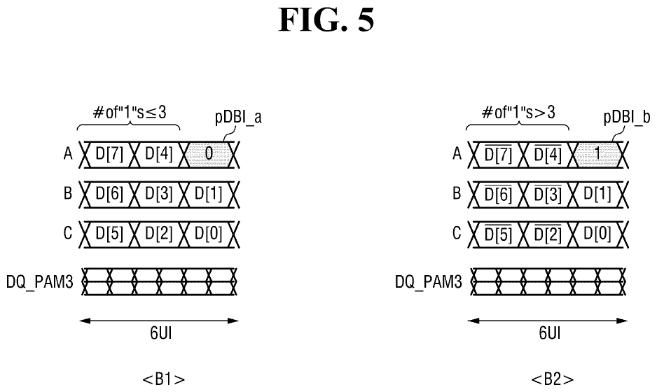

FIG. 5 is a drawing for describing the embedded sequence data of FIG. 1 in detail.

<B1> of FIG. 5 illustrates a case in which pDBI is the second pDBI pDBI_a, and <B2> of FIG. 5 illustrates a case in which pDBI is the first pDBI pDBI_b.

If the result value of the adder exceeds a predetermined criterion (for example, 3), the MSB selector 215 may determine the pDBI as the first pDBI pDBI_b. In this case, the multiplexer 225 of the data inversion unit 220 may perform inversion on the first part D[7:2]. By doing so, partial data bus inversion may be performed on the sequence data Seq.

In this case, the criterion may be determined depending on whether power consumption is reduced due to data bus inversion for the first part D[7:2]. In the present embodiment, the first part D[7:2] may include 6 bits. In this case, if the number of 1s for the 6 bits of the first part D[7:2] exceeds 3, the number of 1s may be reduced when data bus inversion is performed. Accordingly, if data bus inversion is performed, power consumption may be reduced during data transmission. Therefore, in the present embodiment, the criterion may be determined as 3.

On the other hand, if the result value of the adder is lower than or equal to a predetermined criterion (3 in FIG. 5), the MSB selector 215 may determine the pDBI as the second pDBI pDBI_a. In this case, the multiplexer 225 of the data inversion unit 220 may not perform inversion for the first part D[7:2].

In this case, regardless of whether the data bus inversion is performed, the PAM3 output data DQ_PAM3 may be generated at 6 UIs (unit intervals). Here, the UI may indicate a time unit in which data is output, and lanes arranged on the same UI may be output at the same time. For example, pDBI may be converted into PAM3 output data DQ_PAM3 for the same time period at the same time as the first data D[0] and the second data D[1] and output. Similarly, the third to fifth data D[2], D[3], and D[4] may be converted into PAM3 output data DQ_PAM3 for the same time period at the same time and output. The sixth to eighth data D[5], D[6], and D[7] may also be converted into PAM3 output data DQ_PAM3 for the same time period at the same time and output.

The present embodiment may embed pDBI instead of dummy data. Accordingly, while the pin efficiency was about 89% in the past due to the dummy data, the pin efficiency may be maximized to 100% in the present invention.

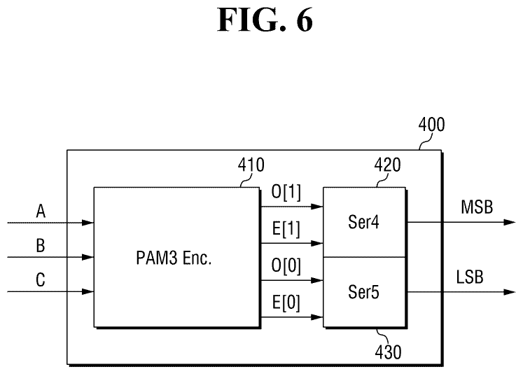

FIG. 6 is a block diagram for describing the modulation encoder of FIG. 1 in detail.

Referring to FIG. 6, the modulation encoder 400 may include a PAM3 encoder 410, a fourth serializer 420, and a fifth serializer 430.

The PAM3 encoder 410 may generate 4-bit intermediate data O[1], E[1], O[0], and E[0] using 3-bit embedded sequence data E_Seq. In this case, the PAM3 encoder 410 may generate intermediate data O[1], E[1], O[0], and E[0] according to a predetermined criterion (for example, a truth table for the values of the first to third lanes).

The fourth serializer 420 may generate the most significant bit (MSB) based on the first intermediate data O[1] and the second intermediate data E[1] output from the PAM3 encoder 410. The most significant bit (MSB) may mean the largest data among the input data.

The fifth serializer 430 may generate the least significant bit (LSB) based on the third intermediate data O[0] and the fourth intermediate data E[0] output from the PAM3 encoder 410. The least significant bit (LSB) may mean the smallest data among the input data.

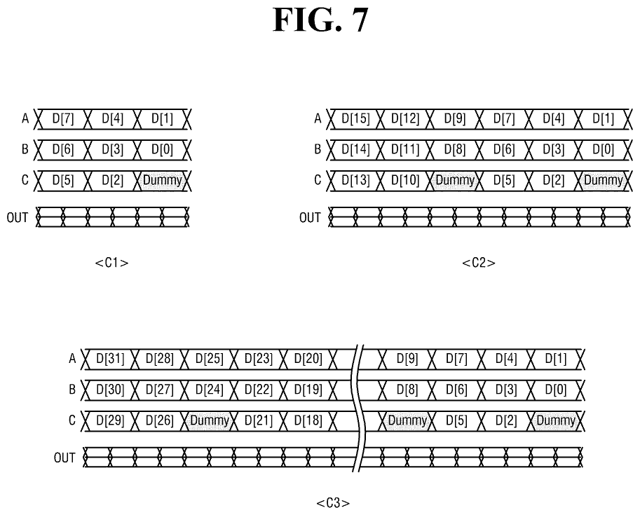

FIG. 7 is a drawing for describing embedded sequence data of FIG. 1.

<C1> of FIG. 7 illustrates a case in which the burst length is 8, and <C2> illustrates a case in which the burst length is 16. <C3> of FIG. 7 illustrates a case in which the burst length is 32.

Referring to <C1>, when the burst length is 8, in the conventional PAM3 signaling method, one dummy data (Dummy) is transmitted together with 8-bit sequence data Seq. On the other hand, in the pDBI encoding method of the present invention, instead of the one dummy data (Dummy), one pDBI may be generated and embedded in the sequence data Seq.

Referring to <C2>, when the burst length is 16, in the conventional PAM3 signaling method, two dummy data (Dummy) are transmitted together with 16-bit sequence data Seq. In this case, the two pieces of dummy data (Dummy) are not adjacent to each other, and one dummy data may be positioned for 8 bits of the sequence data Seq. On the other hand, in the pDBI encoding method of the present invention, instead of the two pieces of dummy data (Dummy), two pDBIs may be generated and embedded in the sequence data Seq.

Referring to <C3>, when the burst length is 32, in the conventional PAM3 signaling method, four pieces of dummy data (Dummy) are transmitted together with the 32-bit sequence data Seq. Similar to <C2>, the four pieces of dummy data (Dummy) are not adjacent to each other, and one dummy data may be positioned for 8 bits of the sequence data Seq. Therefore, in the pDBI encoding method of the present invention, instead of the four pieces of dummy data (Dummy), four pDBIs may be generated and embedded in the sequence data Seq.

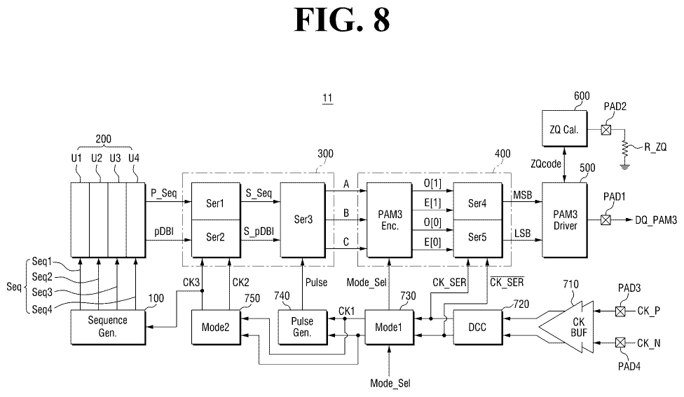

FIG. 8 is a drawing for describing a semiconductor device according to some embodiments of the present invention. The description of those overlapping with those described previously will be simplified or omitted.

Referring to FIG. 8, a semiconductor device 11 may further include a clock buffer 710, a duty cycle corrector 720, a first clock divider 730, a pulse generator 740, a second clock divider 750, a third pad PAD3, and a fourth pad PAD4.

The semiconductor device 11 may receive an up-clock CK_P and a down-clock CK_N from the outside through the third pad PAD3 and the fourth pad PAD4, respectively.

The clock buffer 710 may remove signal noise by adjusting the rising time and falling time.

The duty cycle corrector 720 may adjust the duty of the input clock. Here, the duty may mean the time ratio of a state of logic 1 (high) and a state of logic 0 (low) during one period. The duty cycle corrector 720 may correct the duties of the up-clock CK_P and the down-clock CK_N, respectively, to generate a serial clock CK_SER and an inverse serial clock (“CK_SER”). The duty cycle corrector 720 may transmit the serial clock CK_SER to the fourth serializer 420 and the fifth serializer 430. The duty cycle corrector 720 may also transmit the inverse serial clock (“CK_SER”) to the fourth serializer 420 and the fifth serializer 430.

The first clock divider 730 may divide the frequency of the input clock based on the mode selection signal Mode_Sel to generate a clock having a longer period than the input clock. In FIG. 8, the mode selection signal Mode_Sel may be a signal for the PAM3 signaling method. Accordingly, the first clock divider 730 may divide the frequency of the input serial clock CK_SER and the inverse serial clock (“CK_SER”) by 3 to generate a first clock CK1 having a period 3 times longer.

The pulse generator 740 may receive the first clock CK1 from the first clock divider 730 and generate a pulse. In this case, the pulse generator 740 may generate a pulse having the same period as the first clock CK1 so as to be suitable for the PAM3 signaling method.

The second clock divider 750 may additionally divide the frequency of the first clock CK1 to generate a second clock CK2 and a third clock CK3. For example, the frequency of the second clock CK2 may be 1/2 of the first clock CK1, and the frequency of the third clock CK3 may be ¼ of the first clock CK1. The second clock divider 750 may transmit the second and third clocks CK2 and CK3 to the first and second serializers 310 and 320. In addition, the second clock divider 750 may transmit the third clock CK3 to the sequence generator 100.

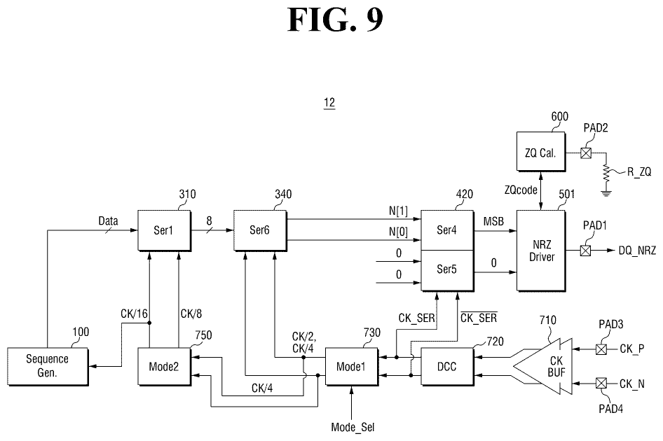

FIG. 9 is a drawing for describing a semiconductor device according to some embodiments of the present invention. The description of those overlapping with those described previously will be simplified or omitted.

Referring to FIG. 9, a semiconductor device 12 of the present invention may operate in an NRZ (Non Return to Zero) signaling method. In this case, the mode selection signal Mode_Sel may be a signal for the NRZ signaling method. The NRZ signaling method may be a signaling method in which the pulse amplitude level is 2.

The first clock divider 730 that receives the mode selection signal Mode_Sel for the NRZ signaling method may divide the clock frequency into ½ and ¼ and transmit the divided clock frequency to the second clock divider 750 and the sixth serializer 340.

The second clock divider 750 may divide the received clock frequency into ½ and ¼ and transmit the divided clock frequencies to the first serializer 310 and the sequence generator 100. For example, when the sequence generator 100 generates 32 bits, the first serializer 310 may receive 32 bits and serialize them in 8-bit units.

The sixth serializer 340 may receive 8 bits from the first serializer 310 and serialize them in 2-bit units. The first bit N[0] and the second bit N[1] output from the sixth serializer 340 may be transmitted to the fourth serializer 420.

The fourth serializer 420 may generate the most significant bit (MSB) using the first bit N[0] and the second bit N[1] and transmit it to an NRZ driver 501. Meanwhile, since the fifth serializer 430 does not have an input value, it may transmit 0 to the NRZ driver 501 accordingly.

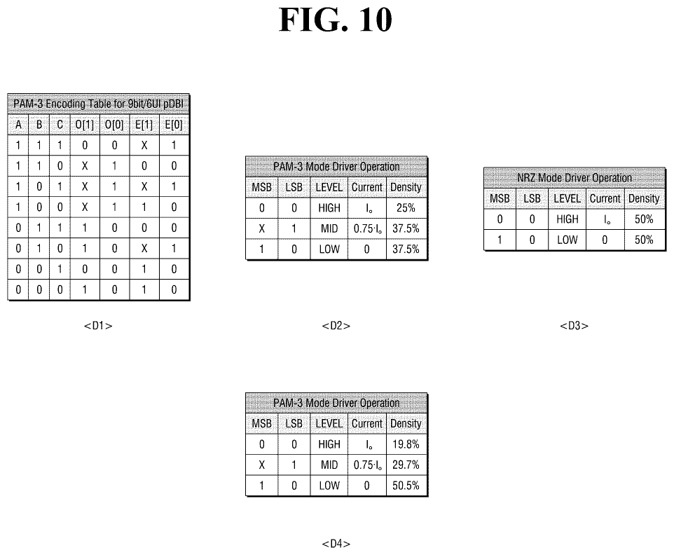

FIG. 10 is a diagram for describing the operation of the modulation encoder and the PAM3 driver of FIG. 8 and the NRZ driver of FIG. 9.

<D1> of FIG. 10 is a table for determining intermediate data O[1], E[1], O[0], and E[0] according to the values of the first to third lanes A, B, and C in the PAM3 encoder 410 of FIG. 8. In the intermediate data O[1], E[1], O[0], and E[0], X means that 0 or 1 is irrelevant.

<D2> is a table for PAM3 output data DQ_PAM3 output from the PAM3 driver 500 according to the most significant bit (MSB) and least significant bit (LSB) output from the fourth serializer 420 and the fifth serializer 430 in the conventional case without pDBI embedding. When the level of the PAM3 output data DQ_PAM3 is high, it may have a density of 25%. On the other hand, when the level of PAM3 output data DQ_PAM3 is mid or low, it may have a density of 37.5%. Accordingly, it may be seen that the average current flowing in the PAM3 driver 500 becomes 0.53I₀.

<D4> is a table for PAM3 output data DQ_PAM3 output from the PAM3 driver 500 according to the most significant bit (MSB) and least significant bit (LSB) output from the fourth serializer 420 and the fifth serializer 430 in the case of the present invention using pDBI. When the level of the PAM3 output data DQ_PAM3 is high, it may have a density of 19.8%. On the other hand, when the level of the PAM3 output data DQ_PAM3 is mid, it may have a density of 29.7%, and when it is low, it may have a density of 50.5%. Accordingly, it may be seen that the average current flowing in the PAM3 driver 500 is 0.42I₀. That is, compared to <D2>, the present invention discloses the effect of reducing current consumption by using pDBI.

<D3> is a table for NRZ output data DQ_NRZ output from the NRZ driver of FIG. 9. The density of the case in which the level of the NRZ output data DQ_NRZ is high and the case in which it is low may be the same at 50%. Accordingly, the average current flowing in the NRZ driver 501 in the NRZ signaling method of the present invention may be 0.5I₀.

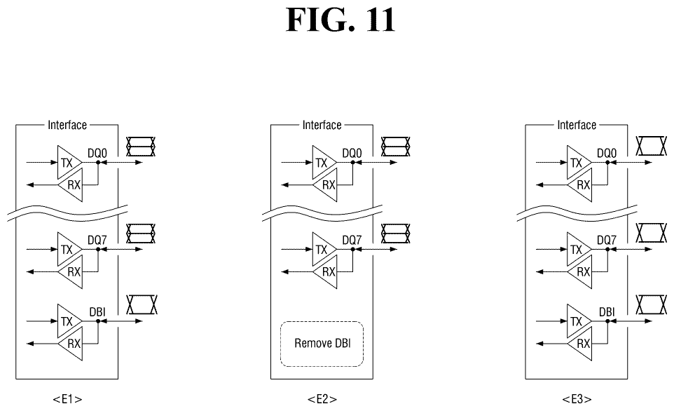

FIG. 11 is a drawing for describing the interface of the semiconductor device of FIG. 8.

<E1> of FIG. 11 illustrates a conventional memory interface using the PAM3 signaling method, and <E2> illustrates a memory interface of a semiconductor device according to some embodiments of the present invention.

Referring to <E1>, the conventional memory interface using the PAM3 signaling method has a separate DBI input/output circuit that transmits a signal for data bus inversion. Accordingly, in addition to the pins for transmitting data DQ0 to DQ7, the area and power for the DBI input/output circuit are required.

Meanwhile, referring to <E3>, in the NRZ signaling method, the conventional memory interface has a separate DBI input/output circuit for transmitting a signal for data bus inversion. Accordingly, in addition to the pins for transmitting data DQ0 to DQ7, the area and power for the DBI input/output circuit are required.

On the other hand, referring to <E2>, using the PAM3 signaling method, the memory interface of the semiconductor device of the present invention enables data bus inversion encoding without a DBI input/output circuit by embedding a signal for data bus inversion into data DQ0 to DQ7. Accordingly, the effect of reducing the area and power consumption occurs compared to the conventional PAM3 signaling method and NRZ signaling method.

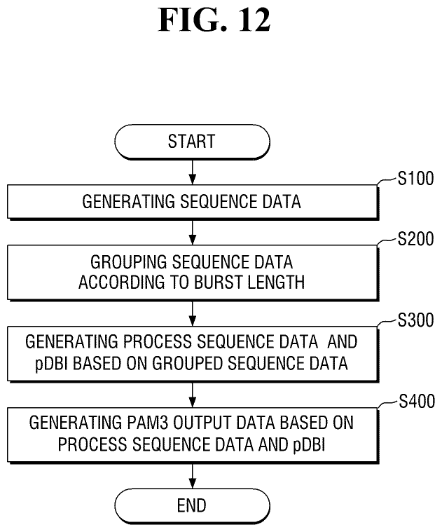

FIG. 12 is a flowchart for describing a pDBI encoding method using a pDBI logic circuit according to some embodiments of the present invention.

Referring to FIG. 12, the semiconductor device of the present invention generates sequence data (S100). Then, the semiconductor device groups the sequence data according to the burst length (S200).

Referring to FIGS. 1 and 2, the semiconductor device 10 may generate 32-bit sequence data Seq. The semiconductor device 10 may group the sequence data Seq according to the burst length. For example, if the burst length of the memory device included in the semiconductor device 10 is 8, the semiconductor device 10 may group the sequence data Seq in 8-bit units. However, the number of bits of the sequence data Seq and the burst length of the memory device may vary as needed.

Subsequently, the semiconductor device generates process sequence data and pDBI based on the grouped sequence data (S300).

The semiconductor device 10 may generate process sequence data P_Seq and pDBI based on the grouped sequence data Seq1 to Seq4. The process sequence data P_Seq may be the result of performing an operation on the sequence data according to the pDBI logic by groups.

In this case, one pDBI may be generated for each group of the sequence data Seq1 to Seq4. For example, if sequence data Seq1 to Seq4 are grouped into four groups, a total of four pDBIs may be generated, one for each group.

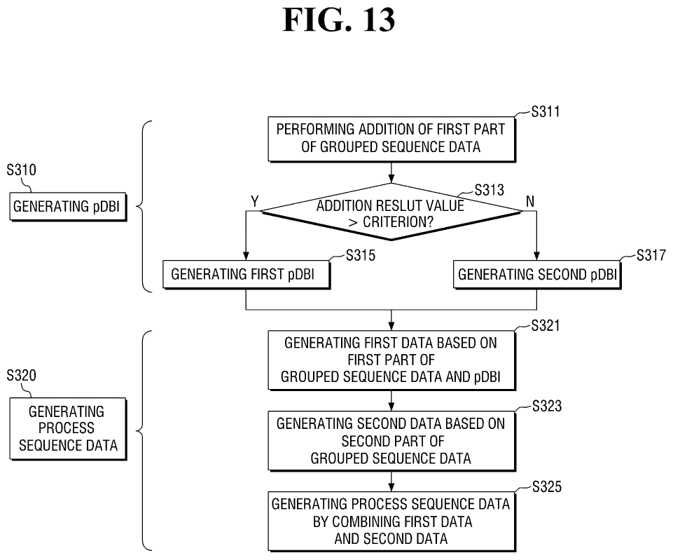

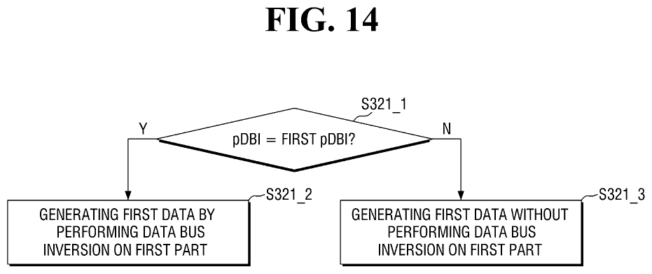

The specific details of generating process sequence data P_Seq and pDBI will be described later with reference to FIGS. 13 and 14.

Subsequently, the semiconductor device generates PAM3 output data based on the process sequence data and pDBI (S400).

The semiconductor device 10 may generate PAM3 output data DQ_PAM3 based on the process sequence data P_Seq and pDBI. The PAM3 output data DQ_PAM3 may be a signal having three levels: high, mid, and low.

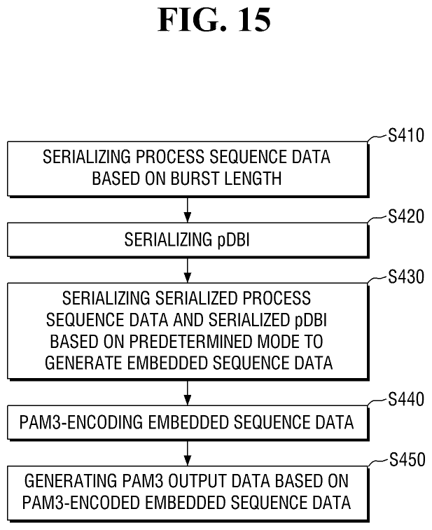

The specific details of generating PAM3 output data will be described later with reference to FIG. 15.

FIG. 13 is a flowchart for describing the process sequence data and pDBI generation steps of FIG. 12 in detail, and FIG. 14 is a flowchart for describing the first data generation step of FIG. 13 in detail.

Referring to FIG. 13, the semiconductor device generates pDBI (S310).

Specifically, the semiconductor device performs addition on the first part of the grouped sequence data (S311).

The semiconductor device 10 may perform addition on the first part D[7:2] of the grouped sequence data Seq1 to Seq4. In this case, the semiconductor device 10 may perform addition on each first part D[7:2] by groups, and calculate the addition value by groups. That is, the addition value for the first part of the first sequence data Seq1, the addition value for the first part of the second sequence data Seq2, the addition value for the first part of the third sequence data Seq3, and the addition value for the first part of the fourth sequence data Seq3 can be calculated, respectively.

Next, the semiconductor device determines whether the addition result exceeds a predetermined criterion (S313). If the addition result exceeds the criterion, the semiconductor device generates a first pDBI (S315). On the other hand, if the addition result is equal to or less than the criterion, the semiconductor device generates a second pDBI (S317).

The semiconductor device 10 may determine whether the addition value exceeds a predetermined criterion. In this case, the semiconductor device 10 may determine whether the addition value for each group of the sequence data Seq exceeds a predetermined criterion.

Referring further to FIG. 5, if the addition value exceeds a predetermined criterion (for example, 3), the semiconductor device 10 may generate a first pDBI pDBI_b (for example, 1). Here, the first pDBI pDBI_b may be a pDBI that causes data bus inversion for the first part D[7:2] to be performed.

If the addition value is equal to or less than the predetermined criterion, the semiconductor device 10 may generate a second pDBI pDBI_a (for example, 0). Here, the second pDBI pDBI_a may be a pDBI that does not cause data bus inversion for the first part D[7:2] to be performed.

Subsequently, the semiconductor device generates process sequence data (S320).

Specifically, the semiconductor device generates the first data based on the first part of the grouped sequence data and the pDBI (S321).

Specifically, referring to FIG. 13, the semiconductor device determines whether the pDBI is the first pDBI (S321_1). If the pDBI is the first pDBI, the semiconductor device performs data bus inversion for the first part to generate the first data (S321_2). On the other hand, if the pDBI is the second pDBI, the semiconductor device generates the first data without performing data bus inversion for the first part (S321_3).

The semiconductor device 10 may determine whether the pDBI is the first pDBI pDBI_b. If the pDBI is the first pDBI pDBI_b, the semiconductor device 10 may perform data bus inversion for the first part D[7:2] to generate the first data. That is, the first data may be data obtained by performing data bus inversion on the first part D[7:2].

On the other hand, if the pDBI is not the first pDBI pDBI_b, the semiconductor device 10 may generate the first data without performing data bus inversion for the first part D[7:2]. In this case, the first data may be the same as the first part D[7:2].

Subsequently, the semiconductor device generates the second data based on the second part of the grouped sequence data (S323).

The semiconductor device 10 may generate the second data based on the second part D[1:0] of the grouped sequence data Seq1 to Seq4. Referring further to <A1> of FIG. 4, the semiconductor device 10 may generate the second data by amplifying the second part D[1:0].

Subsequently, the semiconductor device combines the first data and the second data to generate process sequence data (S325).

The semiconductor device 10 may generate process sequence data P_Seq by combining the first data and the second data. That is, the process sequence data P_Seq may be data in which the sequence data Seq passes through the pDBI logic circuit and data bus inversion is performed on the first part D[7:2] according to the pDBI.

FIG. 15 is a flowchart for describing the PAM3 output data generation step of FIG. 12 in detail.

Referring to FIG. 15, the semiconductor device serializes the process sequence data based on the burst length (S410).

The semiconductor device 10 may serialize the process sequence data P_Seq based on the burst length of the memory device. For example, when the burst length is 8, the semiconductor device 10 may serialize the process sequence data P_Seq by 8 bits.

Subsequently, the semiconductor device serializes the pDBI (S420).

The semiconductor device 10 may serialize the pDBI. In this case, if there is one pDBI, this step may be omitted. For example, if four pDBIs are generated, the semiconductor device 10 may serialize the four pDBIs one by one.

Subsequently, the semiconductor device serializes the serialized process sequence data and the serialized pDBI based on a predetermined mode to generate embedded sequence data (S430).

The semiconductor device 10 may serialize the serialized process sequence data P_Seq and the serialized pDBI to generate embedded sequence data E_Seq. In this case, the semiconductor device 10 may serialize the process sequence data P_Seq and the pDBI by 3 bits each according to a predetermined mode (for example, PAM3). In this case, the embedded sequence data E_Seq may be 3 bits.

Subsequently, the semiconductor device PAM3—encodes the embedded sequence data (S440).

The semiconductor device 10 may PAM3—encode the embedded sequence data E_Seq. For example, the semiconductor device 10 may PAM3—encode the embedded sequence data E_Seq using a predefined PAM3 encoding truth table. By doing so, the semiconductor device 10 may finally generate PAM3 output data DQ_PAM3.

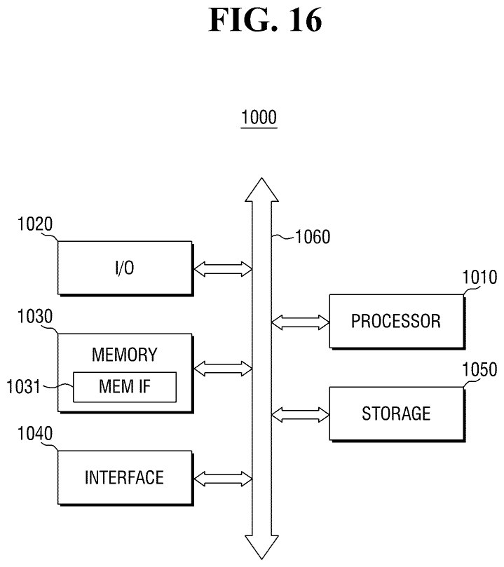

FIG. 16 is a diagram for describing a hardware configuration of a pDBI logic circuit or a semiconductor device that performs a pDBI encoding method according to some embodiments of the present invention.

Referring to FIG. 16, the semiconductor device 10 or the pDBI logic circuit 200 that performs the pDBI encoding method according to some embodiments of the present invention may be implemented as an electronic device 1000. The electronic device 1000 may include a processor 1010, an input/output device (I/O) 1020, a memory 1030, an interface 1040, a storage 1050, and a bus 1060. The processor 1010, the input/output device 1020, the memory 1030, the interface 1040, and/or the storage 1050 may be coupled to each other via a bus 1060. The bus 1060 corresponds to a path through which data is moved.

Specifically, the processor 1010 may include at least one of a central processing unit (CPU), a micro processor unit (MPU), a micro controller unit (MCU), a graphics processing unit (GPU), a microprocessor, a digital signal processor, a microcontroller, an application processor (AP), and logic elements capable of performing functions similar thereto.

The input/output device 1020 may include at least one of a keypad, a keyboard, a touch screen, and a display device.

The memory 1030 may load data and/or a program, and the like. In this case, the memory 1030 may include a high-speed DRAM and/or SRAM, and the like as an operating memory for improving the operation of the processor 1010. The memory 1030 may include one or more volatile memory devices such as a double data rate static DRAM (DDR SDRAM), or a single data rate SDRAM (SDR SDRAM), and/or one or more nonvolatile memory devices such as an electrically erasable programmable ROM (EEPROM) or a flash memory.

The memory 1030 may include a memory interface 1031 for exchanging data within the memory 1030. In addition, the memory interface 1031 may exchange data with other modules within the electronic device 1000 via the bus 1060.

The interface 1040 may perform a function of transmitting data to a communication network or receiving data from a communication network. The interface 1040 may be wired or wireless. For example, the interface 1040 may include an antenna or a wired/wireless transceiver, and the like.

The storage 1050 may store and retain data and/or programs, and the like. The storage 1050 may include one or more nonvolatile memory devices such as a solid state drive (SSD), a hard drive, and a flash memory. In the present invention, the storage 1050 may store a computer program composed of instructions for performing an image-based account transmit service method.

The pDBI logic circuit according to the present embodiment, the semiconductor device including the same, and the pDBI encoding method using the same can transmit DBI encoding data by embedding it in sequence data using the PAM3 signaling method. By doing so, the device can be miniaturized by eliminating the DBI input/output lane, and the pin efficiency can be maximized to minimize power consumption.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

What is claimed is:

1. A pDBI encoding method comprising:
generating sequence data;
grouping the sequence data according to a predetermined burst length;
generating process sequence data and pDBI (partial-Data Bus Inversion) based on the grouped sequence data; and
generating PAM3 (3-level pulse amplitude modulation) output data based on the process sequence data and the pDBI.

2. The pDBI encoding method according to claim 1, wherein
the generating of the process sequence data and the pDBI comprises:
generating the pDBI based on a first part of the grouped sequence data; and
generating the process sequence data based on the grouped sequence data and the pDBI.

3. The pDBI encoding method according to claim 2, wherein
the generating of the pDBI comprises:
performing an addition of the first part;
generating a first pDBI if a result value of the addition exceeds a predetermined criterion; and
generating a second pDBI different from the first pDBI if the result value of the addition is equal to or less than the predetermined criterion.

4. The pDBI encoding method according to claim 2, wherein
the generating of the process sequence data comprises:
generating first data based on the first part of the grouped sequence data and the pDBI;
generating second data based on a second part different from the first part of the grouped sequence data; and
generating the process sequence data by combining the first data and the second data.

5. The pDBI encoding method according to claim 4, wherein
the generating of the first data comprises:
generating the first data by performing data bus inversion on the first part if the pDBI is the first pDBI; and
generating the first data without performing data bus inversion on the first part if the pDBI is not the first pDBI.

6. The pDBI encoding method according to claim 1, wherein
the generating of the PAM3 output data further comprises:
serializing the process sequence data and the pDBI to generate embedded sequence data; and
PAM3—encoding the embedded sequence data to generate the PAM3 output data.

7. The pDBI encoding method according to claim 6, wherein
the generating of the embedded sequence data further comprises:
serializing the process sequence data based on the burst length;
serializing the pDBI; and
serializing the serialized process sequence data and the serialized pDBI based on a predetermined mode to generate the embedded sequence data.

8. The pDBI encoding method according to claim 7, wherein the predetermined mode is a mode for pulse amplitude modulation.

9. A pDBI logic circuit comprising:
a pDBI encoder that generates a pDBI based on a first part of sequence data;
a data inversion unit that generates first data based on the first part of the sequence data and the pDBI; and
an amplifier that amplifies a second part different from the first part of the sequence data to generate second data.

10. The pDBI logic circuit according to claim 9, wherein
the second part is a remaining part of the sequence data excluding the first part.

11. The pDBI logic circuit according to claim 9, wherein
the pDBI encoder comprises:
an adder that receives the first part of the sequence data and performs an addition; and
a Most Significant Bit (MSB) selector that receives a result value of the adder and outputs the pDBI.

12. The pDBI logic circuit according to claim 11, wherein
the MSB selector is configured to:
generate a first pDBI if the result value of the adder exceeds a predetermined criterion, and
generate a second pDBI different from the first pDBI if the result value of the adder is equal to or less than the predetermined criterion.

13. The pDBI logic circuit according to claim 9, wherein
the data inversion unit generates the first data by inverting the first part of the sequence data based on the pDBI.

14. The pDBI logic circuit according to claim 13, wherein
the data inversion unit comprises:
a first part that amplifies the first part;
a second part that inverts the first part; and
a multiplexer which receives the first part and the inverted first part and performs inversion of the first part.

15. A semiconductor device comprising:
a sequence generator that generates sequence data;
a pDBI logic circuit that receives the sequence data according to a predetermined burst length and outputs process sequence data and pDBI for the sequence data; and
a driver that generates PAM3 output data based on the process sequence data and the pDBI, wherein
the pDBI is data regarding whether a data bus inversion occurs between the sequence data and the process sequence data.

16. The semiconductor device according to claim 15, further comprising
a serializer that serializes the process sequence data and the pDBI to output embedded sequence data; and
a PAM3 encoder that PAM3—encodes the embedded sequence data and transmits it to the driver.

17. The semiconductor device according to claim 16, wherein
the serializer comprises:
a first serializer that serializes the process sequence data based on the burst length;
a second serializer that serializes the pDBI; and
a third serializer that serializes the serialized process sequence data and the serialized pDBI based on a predetermined mode.

18. The semiconductor device according to claim 17, wherein
the predetermined mode is a mode for pulse amplitude modulation.
